(19) United States
(12) Patent Application Publication
(10) Pub. No.: US 2015/0068419 A1
(43) Pub. Date: Mar. 12, 2015

(54) RESIN COMPOSITION FOR LASER ENGRAVING, FLEXOGRAPHIC PRINTING PLATE PRECURSOR FOR LASER ENGRAVING AND PROCESS FOR PRODUCING SAME, AND FLEXOGRAPHIC PRINTING PLATE AND PROCESS FOR MAKING SAME

(71) Applicant: FUJIFILM Corporation, Tokyo (JP)

(72) Inventor: Yuichi YASUHARA, Haibara-gun (JP)

(73) Assignee: FUJIFILM Corporation, Tokyo (JP)

(21) Appl. No.: 14/478,761

(22) Filed: Sep. 5, 2014

(30) Foreign Application Priority Data
Sep. 6, 2013 (JP) 2013-184565

(51) Int. Cl. B41N 1/12; B23K 26/14; B23K 26/36; B41N 1/00; B41N 3/03

(52) U.S. Cl. CPC B41N 1/12; B41N 1/00; B41N 3/032; B23K 26/365; B23K 26/1405; B23K 26/1417
USPC 101/395; 525/177; 522/2; 219/121.69

(57) ABSTRACT

Disclosed is a resin composition for laser engraving, comprising (Component A) a hydrocarbon-based plastomer and (Component B) a polyester resin.

### CROSS-REFERENCE TO RELATED APPLICATION

This application claims priority under 35 USC 119 from Japanese Patent Application No. 2013-184565 filed on Sep. 6, 2012, the disclosure of which is incorporated by reference herein.

### TECHNICAL FIELD

The present invention relates to a resin composition for laser engraving, a flexographic printing plate precursor for laser engraving, a process for producing same, a flexographic printing plate and a process for making same.

### BACKGROUND ART

A large number of so-called “direct engraving CTP methods”, in which a relief-forming layer is directly engraved by means of a laser are proposed. In the method, a laser light is directly irradiated to a flexographic printing plate precursor to cause thermal decomposition and volatilization by photothermal conversion, thereby forming a concave part. Differing from a relief formation using an original image film, the direct engraving CTP method can control freely relief shapes. Consequently, when such image as an outline character is to be formed, it is also possible to engrave that region deeper than other regions, or, in the case of a fine halftone dot image, it is possible, taking into consideration resistance to printing pressure, to engrave while adding a shoulder. With regard to the laser for use in the method, a high-power carbon dioxide laser is generally used. In the case of the carbon dioxide laser, all organic compounds can absorb the irradiation energy and convert it into heat. On the other hand, inexpensive and small-sized semiconductor lasers have been developed, wherein, since they emit visible lights and near infrared lights, it is necessary to absorb a laser light and convert it into heat.

As a flexographic printing plate precursor, those described in JP-A-2008-229875 (JP-A denotes a Japanese unexamined patent application publication) or JP-A-2009-23181 are known.

JP-A-2008-229875 discloses a flexographic printing plate precursor in which (A) a support layer, (B) a resin layer formed of an elastomeric composition containing an elastomeric binder and a crosslinking agent which can crosslink the elastomeric binder, and (C) a hydrophilic resin layer are laminated, as a flexographic printing plate precursor that is excellent in elasticity, and in which engraving residues can be easily removed by washing with water after laser engraving.

JP-A-2009-23181 discloses a printing plate precursor composed of a flexible support and a resin composition layer formed on the support, in which the resin composition layer is laser-engravable, and Shore D hardness thereof is in the range of 45° to 95°, as a flexographic printing plate precursor of which shape deterioration due to laser engraving is small.

### SUMMARY OF INVENTION

Objects of the present invention are to provide a resin composition for laser engraving which can give a flexographic printing plate that is excellent in rinsing properties for engraving residue generated at the time of laser engraving and printing durability, to provide a flexographic printing plate precursor for laser engraving that uses the above resin composition for laser engraving, and to provide a process for making a flexographic printing plate using the above flexographic printing plate precursor and the flexographic printing plate obtained by the process.

The objects of the present invention have been attained by means described in <1>, <14>, <15>, <17>, <19>, or <21> below. They are given below together with <2> to <13>, <16>, <18> and <20>, which are preferred embodiments.

<1> A resin composition for laser engraving, comprising: (Component A) a hydrocarbon-based plastomer; and (Component B) a polyester resin.

<2> The resin composition for laser engraving as described in <1>, wherein Component A contains at least one resin selected from a group consisting of a polyolefin resin and a poly-conjugated diene-based resin.

<3> The resin composition for laser engraving as described in <1> or <2>, wherein Component A is polybutadiene or polyisoprene.

<4> The resin composition for laser engraving as described in any one of <1> to <3>, wherein the content of Component A is 15 mass % to 70 mass % relative to the amount of the solid content of the resin composition.

<5> The resin composition for laser engraving as described in any one of <1> to <4>, wherein the content of Component B is 15 mass % to 70 mass % relative to the amount of the solid content of the resin composition.

<6> The resin composition for laser engraving as described in any one of <1> to <5>, wherein the total amount of Component A and Component B is no more than 90 mass % relative to the amount of the solid content of the resin composition.

<7> The resin composition for laser engraving as described in any one of <1> to <6>, further comprising (Component C) a polymerization Initiator, wherein Component B is a polyester resin having a radically polymerizable group in a molecule.

<8> The resin composition for laser engraving as described in <7>, wherein the content of Component C is 5 mass % to 15 mass % relative to the amount of the solid content of the resin composition.

<9> The resin composition for laser engraving as described in any one of <1> to <8>, further comprising (Component D) a polyfunctional ethylenically unsaturated compound having two or more radically polymerizable groups in a molecule.

<10> The resin composition for laser engraving as described in <9>, wherein the content of Component D is 3 mass % to 20 mass % relative to the amount of the solid content of the resin composition.

<11> The resin composition for laser engraving as described in <1> to <10>, further comprising (Component E) a photothermal conversion agent.

<12> The resin composition for laser engraving as described in <11>, wherein the content of Component E is 2 mass % to 60 mass % relative to the amount of the solid content of the resin composition.

<13> The resin composition for laser engraving as described in <11> or <12>, wherein Component C is an organic peroxide, and Component E is carbon black.

<14> A flexographic printing plate precursor for laser engraving, comprising: a relief-forming layer which is formed of the resin composition for laser engraving as described in any one of <1> to <13> and provided on a support.

<15> A flexographic printing plate precursor for laser engraving, comprising: a crosslinked relief-forming layer which is obtained by crosslinking the relief-forming layer formed of the resin composition for laser engraving as described in any one of <7> to <13> by heat and/or light, and which is provided on a support.

<16> The flexographic printing plate precursor for laser engraving as described <15>, wherein the crosslinked relief-forming layer is obtained by crosslinking by heat.

<17> A process for producing a flexographic printing plate precursor for laser engraving, comprising steps of: forming a relief-forming layer formed of the resin composition for laser engraving as described in <7> to <13>; and crosslinking the relief-forming layer by heat and/or light so as to obtain a flexographic printing plate precursor having a crosslinked relief-forming layer.

<18> The process for producing a flexographic printing plate precursor for laser engraving as described in <17>, wherein in the step of crosslinking, the relief-forming layer is crosslinked by heat.

<19> A process for making a flexographic printing plate, comprising steps of: preparing the flexographic printing plate precursor for laser engraving as described in any one of <14> to <16>; and engraving the flexographic printing plate precursor for laser engraving with laser so as to form a relief layer,

<20> The process for making a flexographic printing plate as described in <19>, further comprising, after the step of engraving, a step of rinsing the surface of the relief layer with an aqueous rinsing liquid,

<21> A flexographic printing plate made by the process for making a flexographic printing plate according to <19> or <20>.

### DESCRIPTION OF EMBODIMENTS

### Resin Composition for Laser Engraving

The resin composition for laser engraving (hereinafter, also simply referred to as “resin composition”) contains (Component A) a hydrocarbon-based plastomer and (Component B) a polyester resin.

In the present invention, the description of “a lower limit to an upper limit” representing a numerical range means “equal to or greater than a lower limit and equal to or less than an upper limit”, and “an upper limit to a lower limit” means “equal to or less than an upper limit and equal to or greater than a lower limit”. That is, the numerical range includes an upper limit and a lower limit. In addition, in the present invention, “(Component A) a hydrocarbon-based plastomer” or the like is also simply referred to as “Component A” or the like.

“a (crosslinked) relief-forming layer” or the like has the same meaning as “a relief-forming layer and/or a crosslinked relief-forming layer” or the like, and the same shall apply hereafter.

Hereinafter, first, Components A and B which are essential constituents of the resin composition of the present invention will be described, and then, Components C, D, E, and F which are optional constituents will be described.

### (Component A) a Hydrocarbon-Based Plastomer

The resin composition of the present invention comprises (Component A) a hydrocarbon-based plastomer as an essential component.

The hydrocarbon-based plastomer in the present invention refers to a plastomer of which main chain skeleton is composed of a hydrocarbon, and the structures of chain ends of the plastomer is not particularly limited, as far as they are atoms or groups usually permitted as a polymer terminal.

In the present invention, the “plastomer” refers to a polymer which is easily fluidized and deformed by heating and can be solidified into a shape formed by deformation by cooling, as described in “Polymer Encyclopedia, New Edition” edited by The Society of Polymer Science, Japan (Japan, Asakura Publishing Co., Ltd., 1988). The “plastomer” is a contrasting term of an “elastomer” (a polymer having properties by which the polymer is deformed instantaneously by an external force when the external force is applied thereto and restores its original shape in a short time when the external force is removed). The plastomer does not undergo elastic deformation unlike the elastomer but easily undergoes plastic deformation.

In the present invention, the plastomer refers to a polymer having properties in which if the original size of the polymer is defined as 100%, the polymer can be deformed up to 200% by a small external force at room temperature (20° C.), and even when the external force is removed, the polymer does not shrink to a size equal to or less than 130% of its original size. The “small external force” specifically refers to an external force that results in a tensile strength of 1 to 100 MPa. More specifically, the plastomer refers to a polymer having properties mentioned below. That is, when a tensile test is performed using a dumbbell test specimen type 4 specified in JIS K 6251-1993 at 20° C. based on the tensile permanent set test of JIS K 6262-1997, the polymer can be stretched by two times the gauge length measured before the tensile test, which has not been subjected to the tensile test, without being ruptured, and after the polymer is kept as is for 60 minutes from the point in time when it is stretched by 2 times the gauge length measured before the tensile test, a degree of tensile permanent set of the polymer becomes at least 30% after 5 minutes elapses from when the application of an external tensile strength is removed. In the present invention, the entire test process is based on the tensile permanent set test method of JIS K 6262-1997, except that the specimen is made into a dumbbell type 4 specified in JIS K 6251-1993; the specimen is kept as is for 60 minutes; and the temperature of the test room is set to 20° C.

A polymer that cannot be measured by the aforementioned method, that is, a polymer which is deformed even if an external tensile strength is not applied thereto and does not restore its original shape in a tensile test or a polymer which is ruptured when the small external force used for the aforementioned measurement is applied thereto corresponds to the plastomer.

Furthermore, in the present invention, the plastomer has a glass transition temperature (Tg) of a polymer of lower than 20° C. In the case of a polymer having at least two kinds of Tg, all of them are lower than 20° C. The Tg of a polymer can be measured by differential scanning calorimetry (DSC).

Viscosity of the plastomer of the present invention measured by a B-type viscometer at 20° C. is preferably 10 Pa·s to 10 kPa·s, and more preferably 50 Pa·s to 5 kPa·s. If the viscosity is in the above range, the resin composition is easily formed into a printing plate precursor in the form of a sheet or a cylinder, and the process thereof is also simplified. In the present invention, by using a resin including a plastomer as Component A, when a printing plate precursor for laser engraving obtained therefrom is shaped into a sheet or a cylinder, it is possible to accomplish excellent thickness accuracy or dimensional accuracy.

Examples of such a hydrocarbon-based plastomer include polyolefin resins such as polyethylene and polyisobutylene, and poly-conjugated diene-based resins such as polybutadiene, hydrogenated polybutadiene, polyisoprene, and hydrogenated polyisoprene. Among these, poly-conjugated diene-based resins are preferable, poly-conjugated diene-based resins having a so-called internal olefin bond are more preferable, and polybutadiene or polyisoprene is even more preferable. Polybutadiene or polyisoprene may be partly or fully hydrogenated.

The above polybutadiene may be a polymer of which the main chain has butadiene as a monomer unit, and examples thereof include terminal-modified polybutadiene, partially hydrogenated polybutadiene, and hydrogenated polybutadiene. Commercially available polybutadiene, polybutadiene polyol, and the like may be used, and Kurapuren (registered trademark) LBR series (manufactured by Kuraray Co., Ltd.), Poly bd (manufactured by Idemitsu Kosan Co., Ltd.), UBEPOL series (manufactured by Ube Industries, Ltd.), Nipol (registered trademark) BR Series (manufactured by Nippon Zeon Corporation), and the like can be exemplified.

The above polyisoprene may be a polymer of which the main chain has isoprene as a monomer unit, and examples thereof include terminal-modified polyisoprene, partially hydrogenated polyisoprene, and hydrogenated polyisoprene. Commercially available polyisoprene, polyisoprene polyol, and the like can also be used, and Kurapuren (registered trademark) LIR series (manufactured by Kuraray Co., Ltd.), Nipol (registered trademark) IR Series (manufactured by Nippon Zeon Corporation), and the like can be exemplified.

Both the above polybutadiene and polyisoprene preferably contain 1,4-adductas main component.

The above polyisobutylene may be a polymer of which the main chain has isobutylene as a monomer unit, and examples thereof include terminal-modified polyisobutylene. Commercially available polyisobutylene, polyisobutylene polyol, and the like can also be used, and Epion series (manufactured by Kaneka Corporation) and the like can be exemplified.

The number average molecular weight of each of the above polybutadiene, polyisoprene, and polyisobutylene is preferably 1,000 to 1,500,000, more preferably 1,500 to 500,000, even more preferably 2,000 to 300,000, and particularly preferably 2,500 to 250,000.

In the present invention, the number average molecular weight (Mn) and the weight average molecular weight (Mw) of a resin or the like can be obtained by calibrating and converting a measured value, which is obtained, for example, by gel permeation chromatography (GPC), using polystyrene of which the molecular weight is known.

In the resin composition for laser engraving of the present invention, one type of Component A may be used on its own, or two or more types thereof may be used in combination.

The content of Component A is preferably 10 mass % to 95 mass %, more preferably 15 mass % to 70 mass %, and even more preferably 20 mass % to 60 mass % relative to the amount of the solid content of the resin composition. If the content of Component A is in the above range, a flexible relief layer that is excellent in rinsing properties for engraving residue can be obtained, and thus it is preferable.

As Component A, commercially available products can also be used, and UBEPOL BR (registered trademark) 150L (manufactured by Ube Industries, Ltd.), UBEPOL BR (registered trademark) 130B (manufactured by Ube Industries, Ltd.), Nipol (registered trademark) BR1250H (manufactured by Nippon Zeon Corporation), Nipol (registered trademark) IR2200 (manufactured by Nippon Zeon Corporation), and Epion 100A (manufactured by Kaneka Corporation) can be exemplified.

### (Component B) Polyester Resin

The polyester resin used in the present invention is a resin formed by an esterification reaction or a transesterification reaction of polyvalent carboxylic acid and polyol, or an esterification reaction or a transesterification reaction of hydroxycarboxylic acid.

The above polyvalent carboxylic acid and polyol may include ester-forming derivatives thereof.

The ester-forming derivatives of polyvalent carboxylic acid refer to, for example, salts of polycarboxylic acid, or esters, acid anhydrides or acid chlorides thereof, and the ester-forming derivatives of polyol refer to, for example, alkoxides or ethers of polyol.

As the above esterification reaction or transesterification reaction, the methods that are generally used can be used without particular limitation.

In a case where the polyester resin is a polycondensate of the polyvalent carboxylic acid and the polyol, the total number of monomer units derived from polyvalent carboxylic acid and monomer units derived from polyol is preferably equal to or greater than 2, more preferably equal to or greater than 6, even more preferably equal to or greater than 8, particularly preferably equal to or greater than 10, and preferably equal to or less than 50.

In addition, the polyester resin used in the present invention preferably does not include a urethane bond, a urea bond, or a carbonate bond, and may include an ether bond.

The polyester resin used in the present invention is preferably synthesized by a dehydration condensation of a diol compound and a dicarboxylic acid compound.

As the diol compound and the dicarboxylic acid compound, ester-forming derivatives thereof may be used.

The diol compound is preferably an aliphatic diol, and more preferably a linear aliphatic diol. In addition, the number of carbon atoms in the diol compound is preferably 2 to 20, more preferably 2 to 10, and even more preferably 2 to 5.

The dicarboxylic acid compound is preferably an aliphatic dicarboxylic acid, and more preferably a linear aliphatic dicarboxylic acid. In addition, the number of carbon atoms in the dicarboxylic acid is preferably 4 to 20, more preferably 4 to 14, and even more preferably 4 to 10.

The diol compound and the dicarboxylic acid compound preferably do not have a urethane bond, a urea bond, or a carbonate bond, and may have an ether bond.

Furthermore, in a case where the polyester resin used in the present invention is liquid or solid at an ordinary temperature, the polyester resin is preferably amorphous, and more preferably, the glass transition temperature thereof is lower than 20° C.

Hereinafter, examples of a diol compound and a dicarboxylic acid compound used when synthesizing the polyester resin in the present invention are mentioned, but the present invention is not limited thereto.

Specific examples of the diol compound include ethylene glycol, 1,2-propanediol, 1,3-propanediol, 1,3-butanediol, 2,3-butanediol, 2,2-dimethyl-1,3-propanediol, 1,4-pentanediol, 2,4-pentanediol, 3,3-dimethyl-1,2-butanediol, 2-ethyl-2-methyl-1,3-propanediol, 1,6-hexanediol, 2,5-hexanediol, 2-methyl-2,4-pentanediol, 2,2-diethyl-1,3-propanediol, 2,4-dimethyl-2,4-pentanediol, 2-methyl-2-propyl-1,3-propanediol, 2,5-dimethyl-2,5-hexanediol, 2-ethyl-1,3-hexanediol, 1,2-octanediol, 2,2,4-trimethyl-1,3-pentanediol, 1,4-cyclohexanedimethanol, diethylene glycol, triethylene glycol, dipropylene glycol, tripropylene glycol, polyethylene glycol (average molecular weight is 200, 300, 400, 600, 1,000, 1,500, or 4,000), polypropylene glycol (average molecular weight is 200, 400, or 1,000), polyester polyol, 4,4′-dihydroxy-diphenyl-2,2-propane, 4,4-dihydroxyphenyl sulfone, 2,2-bis(hydroxymethyl)propionic acid, 2,2-bis(hydroxymethyl)butanoic acid, 2,5,6-trimethoxy-3,4-dihydroxyhexanoic acid, 2,3-dihydroxy-4,5-dimethoxypentanoic acid, 2,4-di(2-hydroxy)ethyloxycarbonyl benzenesulfonic acid, and salts of these.

Specific examples of the dicarboxylic acid compound include oxalic acid, malonic acid, succinic acid, glutaric acid, dimethylmalonic acid, adipic acid, pimelic acid, α,α-dimethylsuccinic acid, acetone dicarboxylic acid, sebacic acid, 1,9-nonanedicarboxylic acid, fumaric acid, maleic acid, itaconic acid, citraconic acid, phthalic acid, isophthalic acid, terephthalic acid, 2-butylterephthalic acid, tetrachloroterephthalic acid, acetylenedicarboxylic acid, poly(ethylene terephthalate)dicarboxylic acid, 1,2-cyclohexanedicarboxylic acid, 1,4-cyclohexanedicarboxylic acid, ω-poly(ethyleneoxy)dicarboxylic acid, and p-xylylenedicarboxylic acid.

When performing polycondensation with a diol compound, these compounds may be used in a form of alkyl ester of carboxylic acid (for example, dimethyl ester) or acid chloride of dicarboxylic acid, or may be used in a form of acid anhydride such as maleic anhydride, succinic anhydride, and phthalic anhydride.

The number average molecular weight of the polyester resin is preferably 800 to 500,000, more preferably 1,000 to 300,000, even more preferably 2,000 to 200,000, and particularly preferably 5,000 to 100,000.

If the number average molecular weight of the polyester resin is in the above range, the strength of the relief layer obtained from the resin composition of the present invention is improved and therefore, printing durability of a printing plate is improved, heat decomposability of a relief-forming layer at the time of laser engraving is excellent, and the engraving sensitivity of the relief-forming layer is also excellent. Thus, it is preferable to set the number average molecular weight of the polyester resin in the above range.

The number average molecular weight of the polyester resin can be obtained from a calibration curve in terms of polystyrene using measurement by a GPC.

The polyester resin in the present invention preferably has a radically polymerizable group, more preferably has a (meth)acryloyl group, and even more preferably has a (meth)acryloyloxy group in the molecule thereof. Although the polyester resin may have a radically polymerizable group at any position in the molecule, it is preferable for the polyester resin to have a radically polymerizable group on the terminal of the molecule, and in a case where the polyester resin is a linear polyester resin, it is more preferably for the polyester resin to have a radically polymerizable group on both terminals of the main chain. It is considered that by having a radically polymerizable group on both terminals of the main chain rather than on the side chain, flexibility of a (crosslinked) relief-forming layer and a relief layer is further improved, and ink transferability is further improved. In the present invention, the “main chain” represents a relatively longest bonding chain in a molecule of a polymer compound constituting an oligomer or a polymer, and the “side chain” represents a carbon chain which is branched from the main chain.

The number of the radically polymerizable groups which the polyester resin has is preferably 1 to 10, more preferably 2 to 6, even more preferably 2 to 4, and particularly preferably 2 in one molecule.

In the present invention, “a polyester resin is linear” means that a branched structure, a crosslinked structure, or a network structure is not introduced into the polyester resin, and thus the polyester resin does not contain these structures substantially.

The structure of Component B such as whether it is linear can be identified by conducting various analyses such as an NMR, a pyrolysis GS-MS, a GPC, an HPLC, and a dynamic and static light scattering method in combination.

The method for introducing a (meth)acryloyl group or a (meth)acryloyloxy group into the polyester resin can be performed according to known methods for introducing a functional group into a polyester resin. For example, a method in which a polyester resin having a reactive group on the terminal of the main chain or on the side chain and a compound having a functional group that reacts with the above reactive group and a (meth)acryloyl group or a (meth)acryloyloxy group are subjected to a polymer reaction, and the like can be mentioned.

In the present invention, as the polyester resin having a reactive group on the terminal of the main chain or on the side chain, it is possible to use (i) a polyester resin having a hydroxyl group on the terminal of the molecular. A polyester resin having a hydroxyl group on the terminal of the main chain is preferable, and a polyester resin having a hydroxyl group on both terminals of the main chain is more preferable.

Compound (i) is preferably a resin formed by an esterification reaction or a transesterification reaction of at least one of polybasic acid components and at least one of polyol components.

In addition, as the polyester (meth)acrylate, commercially available products can also be used, and EBECRYL 524, EBECRYL 884, EBECRYL 885 (these are manufactured by Daicel-Cytec Co., Ltd.), Aronix (registered trademark) M-6250 (manufactured by Toagosei Co., Ltd.), OLESTER RA-2003 (manufactured by Mitsui Chemicals, Inc.), and PU-200PA (manufactured by Shin-Nakamura Chemical Co., Ltd.) can be exemplified.

In the resin composition of the present invention, one type of polyester resin may be used on its own, or two or more types thereof may be used in combination.

The content of polyester resin in the resin composition is preferably 5 mass % to 80 mass %, more preferably 15 mass % to 70 mass %, and even more preferably 20 mass % to 50 mass % relative to the amount of the solid content of the resin composition. If the content of Component B is in the above range, a flexible relief layer that is excellent in rinsing properties for engraving residue can be obtained, and thus it is preferable.

The “solid content” has the same meanings as “non-volatile component”, and in a case where a composition includes a solvent, the “solid content” means the composition excluding the solvent.

The total of the content of Component A and the content of Component B is preferably equal to or less than 90 mass %, more preferably equal to or less than 80 mass %, and even more preferably equal to or less than 75 mass % relative to the amount of the solid content.

The resin composition of the present invention may contain at least one component selected from a group consisting of Components C, D, E, and F, which will be described below, as optional components.

### (Component C) Polymerization Initiator

In order to promote the formation of crosslinked structure, the resin composition for laser engraving of the present invention preferably contains (Component C) a polymerization initiator. Component C is preferably a radical polymerization initiator.

As the radical polymerization initiator, radical polymerization initiators known to those skilled in the art can be used without limitation. Any of a thermal polymerization initiator and a photopolymerization initiator can be used, but it is preferable to use a thermal polymerization initiator. Hereinafter, a radical polymerization initiator will be described in detail, but the present invention is not limited to the description.

The (a) aromatic ketones, (b) onium salt compounds, (d) thio compounds, (e) hexaallylbiimidazole compounds, (f) ketoxime ester compounds, (g) borate compounds, (h) azinium compounds, (i) metallocene compounds, (j) active ester compounds, and (k) compounds having a carbon halogen bonding may preferably include compounds described in paragraphs 0074 to 0118 of JP-A-2008-63554.

In the present invention, when applies to the relief-forming layer of the flexographic printing plate precursor, from the viewpoint of engraving sensitivity and making a favorable relief edge shape, (a) aromatic ketones, (c) organic peroxides and (l) azo compounds are more preferable, (a) aromatic ketones and (c) organic peroxides are yet more preferable, and (c) organic peroxides are particularly preferable.

Moreover, (a) aromatic ketones, (c) organic peroxides and (l) azo compounds preferably include the following compounds.

### (a) Aromatic Ketones

Preferred examples of the (a) aromatic ketones as a polymerization initiator that can be used in the present invention include benzophenone- or alkylphenone-based ones such as benzophenone, 4,4′-bis(dimethylamino)benzophenone, 4,4′-bis(diethylamino)benzophenone, 4,4′-dichlorobenzophenone, 1-hydroxycyclohexylphenylketone, 2-benzyl-2-(dimethylamino)-4′-morpholinobutyrophenone, 2-tolyl-2-(dimethylamino)-1-(4-morpholinophenyl)-1-butanone, 2-methyl-4′-(methylthio)-2-morpholinopropiophenone, and among them alkylphenone-based ones are more preferable.

### (c) Organic Peroxide

Preferred examples of the (c) organic peroxide as a polymerization initiator that can be used in the present invention include peroxyester-based ones such as 3,3′,4,4′-tetra(t-butylperoxycarbonyl)benzophenone, 3,3′,4,4′-tetra(t-amylperoxycarbonyl)benzophenone, 3,3′,4,4′-tetra(t-hexylperoxycarbonyl)benzophenone, 3,3′,4,4′-tetra(t-octylperoxycarbonyl)benzophenone, 3,3′,4,4′-tetra(cumylperoxycarbonyl)benzophenone, 3,3′,4,4′-tetra(p-isopropylcumylperoxycarbonyl)benzophenone, di-t-butyldiperoxyisophthalate, t-butylperoxybenzoate, t-butylperoxy-3-methylbenzoate, t-butylperoxylaurate, t-butylperoxypivalate, t-butylperoxy-2-ethylhexanoate, t-butylperoxy-3,5,5-trimethylhexanoate, t-butylperoxyneoheptanoate, t-butylperoxyneodecanoate, and t-butylperoxyacetate, α,α′-di(t-butylperoxy)diisopropylbenzene, t-butylcumylperoxide, di-t-butylperoxide, t-butylperoxyisopropylmonocarbonate, and t-butylperoxy-2-ethylhexylmonocarbonate, and among them peroxyester-based ones are more preferable, and t-butylperoxybenzoate is yet more preferable.

### (l) Azo Compounds

Preferable (l) azo compounds as a polymerization initiator that can be used in the present invention include those such as 2,2′-azobisisobutyronitrile, 2,2′-azobispropionitrile, 1,1′-azobis(cyclohexane-1-carbonitrile), 2,2′-azobis(2-methylbutyronitrile), 2,2′-azobis(2,4-dimethylvaleronitrile), 2,2′-azobis(4-methoxy-2,4-dimethylvaleronitrile), 4,4′-azobis(4-cyanovaleric acid), dimethyl 2,2′-azobis(isobutyrate), 2,2′-azobis(2-methylpropionamideoxime), 2,2′-azobis[2-(2-imidazolin-2-yl)propane], 2,2′-azobis{2-methyl-N-[1,1-bis(hydroxymethyl)-2-hydroxyethyl]propionamide}, 2,2′-azobis[2-methyl-N-(2-hydroxyethyl)propionamide], 2,2′-azobis(N-butyl-2-methylpropionamide), 2,2′-azobis(N-cyclohexyl-2-methylpropionamide), 2,2′-azobis[N-(2-propenyl)-2-methyl-propionamide], 2,2′-azobis(2,4,4-trimethylpentane).

As the polymerization initiator in the present invention, the organic peroxide (c) is preferable from the viewpoint of crosslinkability of the resin composition and, moreover, is particularly preferable from the viewpoint of improvement of engraving sensitivity, which is an unexpected effect.

In the present invention, with regard to the radical polymerization initiator, one type thereof may be used on its own or two or more types may be used in combination.

In the present invention, the content of Component C in the resin composition for laser engraving is preferably 5 to 15 mass % relative to the total solids content, more preferably 5 to 10 mass %, and yet more preferably 5 to 8 mass %.

Moreover, the total amount of Component A, Component B and Component C is preferably no more than 90 mass % of the total solids content, more preferably no more than 80 mass %, and yet more preferably no more than 75 mass %.

Furthermore, as Component C a commercial product may be used, and examples thereof include Perbutyl Z (NOF Corporation).

### (Component D) Polyfunctional Ethylenically Unsaturated Compound Having Two or More Radically Polymerizable Groups in a Molecule

The resin composition for laser engraving of the present invention may contain (Component D) a polyfunctional ethylenically unsaturated compound having two or more radically polymerizable groups in a molecule.

Component D is a polyfunctional ethylenically unsaturated compound having two or more radically polymerizable groups in the molecule thereof. The number of the radically polymerizable groups which Component D has is preferably 2 to 20, more preferably 2 to 6, and particularly preferably 2 in one molecule.

Component D is preferably a low-molecular weight polymerizable compound having a molecular weight of less than 2,000, and more preferably a low-molecular weight polymerizable compound having a (number average) molecular weight of equal to or more than 170 and less than 1,000.

Such polyfunctional ethylenically unsaturated compounds are widely known in this industrial field and can be used in the present invention without particular limitation. Component D includes an ethylenically unsaturated group-containing carboxylic acid, an ester obtained by a reaction between a polyhydric alcohol (polyol) and an ethylenically unsaturated group-containing carboxylic acid (derivative), an amide obtained by a reaction between a polyvalent amine (polyamine) and an ethylenically unsaturated group-containing carboxylic acid, a polyfunctional vinyl ether, and a polyfunctional allyl compound. However, compounds corresponding to Component B (polyester resin) does not correspond to Component D. Detailed explanation is given below.

Examples of the polyfunctional ethylenically unsaturated compound include esters obtained from an unsaturated carboxylic acid (for example, acrylic acid, methacrylic acid, itaconic acid, crotonic acid, isocrotonic acid, and maleic acid) and a polyol, and amides obtained from the above unsaturated carboxylic acid and a polyamide. Among these, esters obtained from an unsaturated carboxylic acid and an aliphatic polyol compound, and amides obtained from an unsaturated carboxylic acid and an aliphatic polyvalent amine compound are preferably used.

Preferable examples of the above aliphatic polyol compound include alkylene diols having 2 to 10 carbon atoms, trimethylol propane, pentaerythritol, dipentaerythritol, and tricyclodecane dimethanol.

In addition, a product of an addition reaction between unsaturated carboxylic acid esters or amides, which have a nucleophilic substituent such as a hydroxyl group or an amino group, and polyfunctional isocyanates or epoxies, a product of a dehydration condensation reaction between the above unsaturated carboxylic acid esters or amides and polyfunctional carboxylic acids, and the like are also suitably used. Moreover, a product of an addition reaction between unsaturated carboxylic acid esters or amides, which have an electrophilic substituent such as a isocyanate group or an epoxy group, and monofunctional or polyfunctional alcohols or amines, and a product of a substitution reaction between unsaturated carboxylic acid esters or amides, which have a leaving substituent such as a halogen atom or a tosyloxy group, and monofunctional or polyfunctional alcohols or amines are also suitably used. Furthermore, as other examples, instead of the above unsaturated carboxylic acids, compound groups such as vinyl compounds, allyl compounds, unsaturated phosphonic acids, and styrene can also be used.

From the viewpoint of reactivity, the radically polymerizable group contained in the polyfunctional ethylenically unsaturated compound is preferably a (meth)acryloyl group, more preferably a (meth)acryloyloxy group.

Specific examples of ester monomers comprising an ester of an aliphatic polyhydric alcohol compound and an unsaturated carboxylic acid (hereinafter, also simply referred to as “ester monomers”) include acrylic acid esters such as ethylene glycol diacrylate, diethylene glycol diacrylate, triethylene glycol diacrylate, polyethylene glycol diacrylate, 1,3-butanediol diacrylate, tetramethylene glycol diacrylate, propylene glycol diacrylate, neopentyl glycol diacrylate, trimethylolpropane triacrylate, trimethylolpropane tri(acryloyloxypropyl) ether, trimethylolethane triacrylate, hexanediol diacrylate, 1,4-cyclohexanediol diacrylate, tetraethylene glycol diacrylate, polytetramethylene glycol diacrylate, 1,8-octanediol diacrylate, 1,9-nonanediol diacrylate, 1,10-decanediol diacrylate, tricyclodecanedimethanol diacrylate, trimethylolpropane triacrylate, trimethylolpropanetri(acryloiloxypropyl) ether, ditirimethylolethane tetraacrylate, trimethylol ethane triacrylate, pentaerythritol diacrylate, pentaerythritol triacrylate, pentaerythritol tetraacrylate, dipentaerythritol diacrylate, dipentaerythritol hexaacrylate, sorbitol triacrylate, sorbitol tetraacrylate, sorbitol pentaacrylate, sorbitol hexaacrylate, tri(acryloyloxyethyl) isocyanurate, and a polyester acrylate oligomer.

Examples of methacrylic acid esters include tetramethylene glycol dimethacrylate, ethylane glycol dimethacrylate, dietylene glycol dimethacrylate, triethylene glycol dimethacrylate, polyethylene glycol dimethacrylate, propyleneglycol dimethacrylate, dipropylene glycol dimethacrylate, tripropyleneglycol dimethacrylate, tripropylene glycol dimethacrylate, polypropylene glycol dimethacrylate, neopentyl glycol dimethacrylate, trimethylolpropane trimethacrylate, trimethylolethane trimethacrylate, ethylene glycol dimethacrylate, 1,3-butanediol dimethacrylate, hexanediol dimethacrylate, 1,8-octanediol dimethacrylate, 1,9-nonanediol dimethacrylate, 1,10-decanediol dimethacrylate, pentaerythritol dimethacrylate, pentaerythritol trimethacrylate, pentaerythritol tetramethacrylate, dipentaerythritol dimethacrylate, dipentaerythritol hexamethacrylate, sorbitol trimethacrylate, sorbitol tetramethacrylate, bis[p-(3-methacryloxy-2-hydroxypropoxy)phenyl]dimethylmethane, and bis[p-(methacryloxyethoxy)phenyl]dimethylmethane.

Examples of itaconic acid esters include ethylene glycol diitaconate, propylene glycol diitaconate, 1,3-butanediol diitaconate, 1,4-butanediol diitaconate, tetramethylene glycol diitaconate, pentaerythritol diitaconate, and sorbitol tetraitaconate.

Examples of crotonic acid esters include ethylene glycol dicrotonate, tetramethylene glycol dicrotonate, pentaerythritol dicrotonate, and sorbitol tetracrotonate.

As isocrotonic acid esters there can be cited ethylene glycol diisocrotonate, pentaerythritol diisocrotonate, and sorbitol tetraisocrotonate.

As maleic acid esters there can be cited ethylene glycol dimaleate, triethylene glycol dimaleate, pentaerythritol dimaleate, and sorbitol tetramaleate.

As examples of other esters, aliphatic alcohol-based esters described in JP-B-46-27926 (JP-B denotes a Japanese examined patent application publication), JP-B-51-47334 and JP-A-57-196231, those having an aromatic skeleton described in JP-A-59-5240, JP-A-59-5241, and JP-A-2-226149, those having an amino group described in JP-A-1-165613, etc. may also be used preferably.

The above-mentioned ester monomers may be used as a mixture.

Furthermore, a urethane-based addition-polymerizable compound produced by an addition reaction of an isocyanate and a hydroxy group is also suitable, and specific examples thereof include a polyfunctional ethylenically unsaturated compound in which a hydroxy group-containing ethylenically unsaturated compound represented by Formula (4) below is added to a polyisocyanate compound having two or more isocyanate groups per molecule described in JP-B-48-41708.

Furthermore, a urethane-based addition-polymerizable compound produced by an addition reaction of an isocyanate and a hydroxy group is also suitable, and specific examples thereof include a polyfunctional ethylenically unsaturated compound in which a hydroxy group-containing ethylenically unsaturated compound represented by Formula (1) below is added to a polyisocyanate compound having two or more isocyanate groups per molecule described in JP-B-48-41708.

CH₂═C(R)COOCH₂CH(R′)OH (1)

wherein R and R′ independently denote H or CH₃.

Furthermore, urethane acrylates described in JP-A-51-37193, JP-B-2-32293, and JP-B-2-16765, and urethane compounds having an ethylene oxide-based skeleton described in JP-B-58-49860, JP-B-56-17654, JP-B-62-39417, JP-B-62-39418 are also suitable.

Furthermore, by use of an addition-polymerizable compound having an amino structure in the molecule described in JP-A-63-277653, JP-A-63-260909, and JP-A-1-105238, a resin composition having excellent curing speed can be obtained.

Other examples include polyester acrylates such as those described in JP-A-48-64183, JP-B-49-43191, and JP-B-52-30490, and polyfunctional acrylates and methacrylates such as epoxy acrylates formed by a reaction of an epoxy resin and (meth)acrylic acid. Examples also include specific unsaturated compounds described in JP-B-46-43946, JP-B-1-40337, and JP-B-1-40336, and vinylphosphonic acid-based compounds described in JP-A-2-25493. In some cases, perfluoroalkyl group-containing structures described in JP-A-61-22048 are suitably used. Moreover, those described as photocuring monomers or oligomers in the Journal of the Adhesion Society of Japan, Vol. 20, No. 7, pp. 300 to 308 (1984) may also be used.

Examples of the vinyl compounds include butanediol-1,4-divinyl ether, ethylene glycol divinyl ether, 1,2-propanediol divinyl ether, 1,3-propanediol divinyl ether, 1,3-butanediol divinyl ether, 1,4-butanediol divinyl ether, neopentyl glycol divinyl ether, trimethylolpropane tirvinyl ether, trimethylolethane tirvinyl ether, hexanediol divinyl ether, tetraethylene glycol divinyl ether, pentaerythritol divinyl ether, pentaerythritol tirvinyl ether, pentaerythritol tetravinyl ether, sorbitol tetravinyl ether, sorbitol pentavinyl ether, ethylene glycol diethylenevinyl ether, ethylene glycol dipropylenevinyl ether, trimethylolpropane triethylenevinyl ether, trimethylolpropane diethylenevinyl ether, pentaerythritol diethylenevinyl ether, pentaerythritol triethylenevinyl ether, pentaerythritol tetraethylenevinyl ether, 1,1,1-tris[4-(2-vinyloxyethoxyl)phenyl]ethane, bisphenol A divinyloxyethyl ether, divinyl adipate, etc.

Examples of the allyl compounds include polyethylene glycol diallyl ether, 1,4-cyclohexane diallyl ether, 1,4-diethylcyclohexyl diallyl ether, 1,8-octane diallyl ether, trimethylolpropane diallyl ether, trimethylolethane triallyl ether, pentaerythritol triallyl ether, pentaerythritol tetraallyl ether, dipentaerythritol pentaallyl ether, dipentaerythritol hexaallyl ether, diallyl phthalate, diallyl terephthalate, diallyl isophthalate, triallyl isocyanurate, triallyl phosphate, etc.

Among them, Component D is preferably an ester between an aliphatic polyhydric alcohol compound and (meth)acrylic acid; preferred examples include diethylene glycol di(meth)acrylate, dipentaerythritol hexa(meth)acrylate, tricyclodecanedimethanol di(meth)acrylate, trimethylolpropane tri(meth)acrylate, pentaerythritol tetra(meth)acrylate, and 1,6-hexanediol di(meth)acrylate.

Furthermore, Component D may be a commercially available product, and examples thereof include hexanediol diacrylate (Dai-lchi Kogyo Seiyaku Co., Ltd.) and trimethylolpropane triacrylate (Shin-Nakamura Chemical Co., Ltd.).

With regard to Component D, one type thereof may be used on its own or two or more types may be used in combination.

The content of Component D is preferably 3 to 20 mass % relative to the solids content total mass of the resin composition for laser engraving, more preferably 10 to 20 mass %.

### (Component E) Photothermal Conversion Agent

The resin composition for laser engraving of the present invention preferably comprises a photothermal conversion agent, and more preferably comprises the photothermal conversion agent that can absorb light having a wavelength of 700 nm to 1,300 nm. It is surmised that the photothermal conversion agent absorbs laser light and generates heat thus promoting thermal decomposition of a cured material of the resin composition for laser engraving of the present invention during laser engraving. Because of this, it is preferable to select a photothermal conversion agent that absorbs light having the wavelength of the laser that is used for engraving.

When a laser (a YAG laser, a semiconductor laser, a fiber laser, a surface emitting laser, etc.) emitting infrared at a wavelength of 700 to 1,300 nm is used as a light source for laser engraving, it is preferable for the flexographic printing plate precursor for laser engraving which is produced by using the resin composition for laser engraving of the present invention to comprise a photothermal conversion agent that has a maximun absorption wavelength at 700 to 1,300 nm.

As the photothermal conversion agent in the present invention, various types of dye or pigment are used.

With regard to the photothermal conversion agent, examples of dyes that can be used include commercial dyes and known dyes described in publications such as ‘Senryo Binran’ (Dye Handbook) (Ed. by The Society of Synthetic Organic Chemistry, Japan, 1970). Specific preferable examples include dyes having a maximum absorption wavelength from 700 nm to 1,300 nm, and such preferable examples include azo dyes, metal complex salt azo dyes, pyrazolone azo dyes, naphthoquinone dyes, anthraquinone dyes, phthalocyanine dyes, carbonium dyes, diimmonium compounds, quinone imine dyes, methine dyes, cyanine dyes, squarylium colorants, pyrylium salts, and metal thiolate complexes.

In particular, cyanine-based colorants such as heptamethine cyanine colorants, oxonol-based colorants such as pentamethine oxonol colorants, and phthalocyanine-based colorants are preferably used. Examples include dyes described in paragraphs 0124 to 0137 of JP-A-2008-63554.

With regard to the photothermal conversion agent used in the present invention, examples of pigments include commercial pigments and pigments described in the Color Index (C.I.) Handbook, ‘Saishin Ganryo Binran’ (Latest Pigments Handbook) (Ed. by Nippon Ganryo Gijutsu Kyokai, 1977), ‘Saisin Ganryo Ouyogijutsu’ (Latest Applications of Pigment Technology) (CMC Publishing, 1986), ‘Insatsu Inki Gijutsu’ (Printing Ink Technology) CMC Publishing, 1984).

Examples of the type of pigment include black pigments, yellow pigments, orange pigments, brown pigments, red pigments, violet pigments, blue pigments, green pigments, fluorescent pigments, metal powder pigments, and other polymer-bonding colorants. Specific examples include insoluble azo pigments, azo lake pigments, condensed azo pigments, chelate azo pigments, phthalocyanine-based pigments, anthraquinone-based pigments, perylene and perinone-based pigments, thioindigo-based pigments, quinacridone-based pigments, dioxazine-based pigments, isoindolinone-based pigments, quinophthalone-based pigments, dyed lake pigments, azine pigments, nitroso pigments, nitro pigments, natural pigments, fluorescent pigments, inorganic pigments, and carbon black. Among these pigments, carbon black is preferable.

Any carbon black, regardless of classification by ASTM and application (e.g. for coloring, for rubber, for dry cell, etc.), may be used as long as dispersibility, etc. in the composition is stable. Carbon black includes for example furnace black, thermal black, channel black, lamp black, and acetylene black. In order to make dispersion easy, a black colorant such as carbon black may be used as color chips or a color paste by dispersing it in nitrocellulose or a binder in advance using, as necessary, a dispersant, and such chips and paste are readily available as commercial products.

In the present invention, it is possible to use carbon black having a relatively low specific surface area and a relatively low DBP (dibutyl phthalate) absorption and also finely divided carbon black having a large specific surface area. Preferred examples of carbon black include Printex (registered trademark) U, Printex (registered trademark) A, Spezialschwarz (registered trademark) 4 (Degussa), and #45L (Mitsubishi Chemical Corporation).

The carbon black that can be used in the present invention has preferably a DBP absorption number of less than 150 mL/100 g, more preferably no greater than 100 mL/100 g, and yet more preferably no greater than 70 mL/100 g. From the viewpoint of improving engraving sensitivity by efficiently transmitting heat generated by photothermal conversion to the surrounding polymer, etc., the carbon black is preferably a conductive carbon black having a specific surface area of at least 100 m²/g.

The above-mentioned carbon black may be acidic or basic carbon black. The carbon black is preferably basic carbon black. It is of course possible to use a mixture of different carbon blacks.

When carbon black is used as the photothermal conversion agent, thermal crosslinking is more preferable in point of the curability of the film, instead of the photo crosslinking using UV light etc., and, by the combination with the organic peroxide as the polymerization initiator, which is the aforementioned preferable component for use in combination, the engraving sensitivity becomes extremely high, more preferably.

In the resin composition for laser engraving of the present invention, it is preferable that the polymerization initiator and the photothermal conversion agent capable of absorbing light having a wavelength of 700 to 1,300 nm be used in combination, and it is particularly preferable that the organic peroxide and carbon black be used in combination. In the above embodiment, during laser engraving, the polymerization initiator remaining in the (crosslinked) relief-forming layer is decomposed by heat generated from the photothermal conversion agent to promote the decomposition of Component A or the like, thereby improving the engraving sensitivity.

Component E in the resin composition for laser engraving of the present invention may be used singly or in a combination of two or more compounds.

The content of the photothermal conversion agent capable of absorbing light having a wavelength of 700 to 1,300 nm in the resin composition for laser engraving of the present invention largely depends on the size of the molecular extinction coefficient characteristic to the molecule, and is preferably 0.01 to 20 mass % relative to the total solids content of the resin composition, more preferably 0.05 to 15 mass %, and yet more preferably 0.1 to 10 mass %.

### (Component F) Solvent

The resin composition for laser engraving of the present invention may contain a solvent.

As the solvent used when the resin composition for laser engraving of the present invention is prepared, it is preferable to mainly use an aprotic organic solvent from the viewpoint of the solubility of the respective components constituting the resin composition. More specifically, an aprotic organic solvent and a protic organic solvent are used preferably in the ratio (aprotic organic solvent/protic organic solvent) of 100/0 to 50/50 (weight ratio), more preferably in the ratio of 100/0 to 70/30 (weight ratio), and even more preferably in the ratio of 100/0 to 90/10 (weight ratio).

Preferable specific examples of the aprotic organic solvent include acetonitrile, tetrahydrofuran, dioxane, toluene, propylene glycol monomethyl ether acetate, methyl ethyl ketone, acetone, methyl isobutyl ketone, ethyl acetate, butyl acetate, ethyl lactate, N,N-dimethylacetamide, N-methylpyrrolidone, and dimethyl sulfoxide.

Preferable specific examples of the protic organic solvent include methanol, ethanol, 1-propanol, 2-propanol, 1-butanol, 1-methoxy-2-propanol, ethylene glycol, diethylene glycol, and 1,3-propanediol.

Among these, as the aprotic organic solvent, propylene glycol monomethyl ether acetate is preferably used.

After forming a relief-forming layer formed of the resin composition for laser engraving, Component F is preferably removed from the relief-forming layer.

### <Other Additives>

The resin composition for laser engraving of the present invention may comprise as appropriate various types of known additives other than Component A to Component F as long as the effects of the present invention are not inhibited. Examples include a wax, a process oil, a metal oxide, an antiozonant, an anti-aging agent, a thermopolymerization inhibitor, and a colorant, and one type thereof may be used on its own or two more types may be used in combination.

In the resin composition for laser engraving of the present invention, as an additive for improving engraving sensitivity, it is preferable that a nitrocellulose or highly heat-conductive material be added.

The nitrocellulose is a self-reactive compound, during laser engraving, the nitrocellulose itself generates heat to assist the thermal decomposition of the binder polymer such as a coexisting hydrophilic polymer. As a result, it is assumed that engraving sensitivity is improved.

The highly heat-conductive material is added for the purpose of assisting heat conduction, and examples of the heat-conductive material include an inorganic compound such as metal particles and an organic compound such as a conductive polymer. As the metal particles, small gold particles, small silver particles, and small copper particles having a particle size in the order of micrometers to several nanometers are preferable. As the conductive polymer, a conjugated polymer is particularly preferable, and specific examples thereof include polyaniline and polythiophene.

In addition, by using a co-sensitizer, the sensitivity when the resin composition for laser engraving is cured by light is further improved.

Further, during the production and preservation of composition, it is preferable that a small amount of thermal polymerization inhibitor be added for preventing unnecessary thermal polymerization of the polymerizable compound.

For the purpose of coloring the resin composition for laser engraving, colorant such as dye or pigment may be added. Accordingly, properties such as visibility of the image section and aptitude for an image density measuring machine can be improved.

### (Flexographic Printing Plate Precursor for Laser Engraving)

A first embodiment of the flexographic printing plate precursor for laser engraving of the present invention comprises a relief-forming layer formed from the resin composition for laser engraving of the present invention.

A second embodiment of the flexographic printing plate precursor for laser engraving of the present invention comprises a crosslinked relief-forming layer formed by crosslinking a relief-forming layer formed from the resin composition for laser engraving of the present invention.

In the present invention, the ‘flexographic printing plate precursor for laser engraving’ means both or one of a plate having a crosslinkable relief-forming layer formed from the resin composition for laser engraving in a state before being crosslinked and a plate in a state in which it is cured by light and/or heat.

In the present invention, the ‘relief-forming layer’ means a layer in a state before being crosslinked, that is, a layer formed from the resin composition for laser engraving of the present invention, which may be dried as necessary.

When a printing plate precursor having a crosslinked relief-forming layer is laser-engraved, the “flexographic printing plate” is produced.

In the present invention, the ‘crosslinked relief-forming layer’ means a layer formed by crosslinking the relief-forming layer. The crosslinking is preferably carried out by means of heat and/or light. Furthermore, the crosslinking is not particularly limited as long as it is a reaction by which the resin composition is cured, and it is a concept that includes a structure crosslinked due to reactions between Component A's, Component B's, Component D's, and Component A, Component B and Component D and other Component.

The ‘flexographic printing plate’ is prepared by laser engraving a printing plate precursor having a crosslinked relief-forming layer.

Moreover, in the present invention, the ‘relief layer’ means a layer of the flexographic printing plate formed by engraving using a laser, that is, the (crosslinked) relief-forming layer after laser engraving.

The resin composition for laser engraving of the present invention can also be widely used without particular limitation for uses other than formation of a relief-forming layer of a flexographic printing plate precursor on which laser engraving is performed. For example, the resin composition for laser engraving of the present invention can be applied to not only the relief-forming layer of the printing plate precursor that is laser-engraved for forming a convex relief, which will be described below in detail, but also to formation of other materials on the surfaces of which a relief structure or an opening portion is formed, for example, formation of various printing plates on which necessary image is formed by laser engraving, such as an intaglio plate, a stencil plate, and a stamp, or formation of various molded bodies.

In particular, the resin composition of the present invention is preferably used for forming a relief-forming layer on a suitable support to produce a flexographic printing plate precursor for laser engraving.

A flexographic printing plate precursor for laser engraving of the present invention comprises a relief-forming layer formed from the resin composition for laser engraving of the present invention, which has the above-mentioned components. The (crosslinked) relief-forming layer is preferably provided above a support.

The (crosslinked) flexographic printing plate precursor for laser engraving may further comprise, as necessary, an adhesive layer between the support and the (crosslinked) relief-forming layer and, above the relief-forming layer, a slip coat layer and a protection film.

### <Relief-Forming Layer>

The relief-forming layer is a layer formed from the resin composition for laser engraving of the present invention and is preferably a heat-crosslinkable layer.

As a mode in which a flexographic printing plate is prepared using the flexographic printing plate precursor for laser engraving, a mode in which a flexographic printing plate is prepared by crosslinking a relief-forming layer to thus form a flexographic printing plate precursor having a crosslinked relief-forming layer, and the crosslinked relief-forming layer (hard relief-forming layer) is then laser-engraved to thus form a relief layer is preferable. By crosslinking the relief-forming layer, it is possible to prevent abrasion of the relief layer during printing, and it is possible to obtain a flexographic printing plate having a relief layer with a sharp shape after laser engraving.

The relief-forming layer may be formed by molding the resin composition for laser engraving that has the above-mentioned components for a relief-forming layer into a sheet shape or a sleeve shape. The relief-forming layer is usually provided above a support, which is described later, but it may be formed directly on the surface of a member such as a cylinder of equipment for plate making or printing or may be placed and immobilized thereon, and a support is not always required.

A case in which the relief-forming layer is mainly formed in a sheet shape is explained as an example below.

### <Support>

A material used for the support of the flexographic printing plate precursor for laser engraving is not particularly limited, but one having high dimensional stability is preferably used, and examples thereof include metals such as steel, stainless steel, or aluminum, plastic resins such as a polyester (e.g. PET (polyethylene terephthalate), PBT (polybutylene terephthalate), or PAN (polyacrylonitrile)) or polyvinyl chloride, synthetic rubbers such as styrene-butadiene rubber, and glass fiber-reinforced plastic resins (epoxy resin, phenolic resin, etc.). As the support, a PET film or a steel substrate is preferably used. The configuration of the support depends on whether the relief-forming layer is in a sheet shape or a sleeve shape.

### <Adhesive Layer>

An adhesive layer may be provided between the relief-forming layer and the support for the purpose of strengthening the adhesion between the two layers. Examples of materials (adhesives) that can be used in the adhesive layer include those described in ‘Handbook of Adhesives’, Second Edition, Ed by I. Skeist, (1977).

### <Protection Film, Slip Coat Layer>

For the purpose of preventing scratches or dents in the relief-forming layer surface or the crosslinked relief-forming layer surface, a protection film may be provided on the relief-forming layer surface or the crosslinked relief-forming layer surface. The thickness of the protection film is preferably 25 to 500 μm, and more preferably 50 to 200 μm. The protection film may employ, for example, a polyester-based film such as PET or a polyolefin-based film such as PE (polyethylene) or PP (polypropylene). The surface of the film may be made matte. The protection film is preferably peelable.

When the protection film is not peelable or conversely has poor adhesion to the relief-forming layer, a slip coat layer may be provided between the two layers. The material used in the slip coat layer preferably employs as a main component a resin that is soluble or dispersible in water and has little tackiness, such as polyvinyl alcohol, polyvinyl acetate, partially saponified polyvinyl alcohol, a hydroxyalkylcellulose, an alkylcellulose, or a polyamide resin.

### (Process for Producing Flexographic Printing Plate Precursor for Laser Engraving)

Formation of a relief-forming layer in the flexographic printing plate precursor for laser engraving is not particularly limited, and examples thereof include a method in which the resin composition for laser engraving is prepared, solvent is removed as necessary from this resin composition for laser engraving, and it is melt-extruded onto a support. Alternatively, a method may be employed in which the resin composition for laser engraving is cast onto a support, and this is dried in an oven to thus remove solvent from the resin composition.

Among them, the process for making a flexographic printing plate for laser engraving of the present invention is preferably a production process comprising a layer formation step of forming a relief-forming layer from the resin composition for laser engraving of the present invention and a crosslinking step of crosslinking the relief-forming layer by means of heat and/or light to thus obtain a flexographic printing plate precursor having a crosslinked relief-forming layer.

Subsequently, as necessary, a protection film may be laminated on the relief-forming layer. Laminating may be carried out by compression-bonding the protection film and the relief-forming layer by means of heated calendar rollers, etc. or putting a protection film into intimate contact with a relief-forming layer whose surface is impregnated with a small amount of solvent.

When a protection film is used, a method in which a relief-forming layer is first layered on a protection film and a support is then laminated may be employed.

When an adhesive layer is provided, it may be dealt with by use of a support coated with an adhesive layer. When a slip coat layer is provided, it may be dealt with by use of a protection film coated with a slip coat layer.

### <Layer Formation Step>

The process for making the flexographic printing plate precursor for laser engraving of the present invention preferably comprises a layer formation step of forming a relief-forming layer from the resin composition for laser engraving of the present invention.

Preferred examples of a method for forming a relief-forming layer include a method in which the resin composition for laser engraving of the present invention is prepared, solvent is removed as necessary from this resin composition for laser engraving, and it is then melt-extruded onto a support and a method in which the resin composition for laser engraving of the present invention is prepared, the resin composition for laser engraving of the present invention is cast onto a support, and this is dried in an oven to thus remove the solvent.

The resin composition for laser engraving may be produced by, for example, dissolving Component A to Component E, and as optional components Component E in an appropriate solvent. Since it is necessary to remove most of the solvent component in a stage of producing a flexographic printing plate precursor, it is preferable to use as the solvent a volatile low-molecular-weight alcohol (e.g. methanol, ethanol, n-propanol, isopropanol, propylene glycol monomethyl ether), etc., and adjust the temperature, etc. to thus reduce as much as possible the total amount of solvent to be added.

The thickness of the (crosslinked) relief-forming layer in the flexographic printing plate precursor for laser engraving before and after crosslinking is preferably at least 0.05 mm but no greater than 10 mm, more preferably at least 0.05 mm but no greater than 7 mm, and yet more preferably at least 0.05 mm but no greater than 3 mm.

### <Crosslinking Step>

The process for producing a flexographic printing plate precursor for laser engraving of the present invention is preferably a production process comprising a crosslinking step of crosslinking the relief-forming layer by means of light and/or heat to thus obtain a flexographic printing plate precursor having a crosslinked relief-forming layer, and more preferably a production process comprising a crosslinking step of crosslinking the relief-forming layer by heat.

The relief-forming layer may be crosslinked by heating the flexographic printing plate precursor for laser engraving (step of crosslinking by means of heat). As heating means, there can be cited a method in which a printing plate precursor is heated in a hot air oven or a far-infrared oven for a predetermined period of time and a method in which it is put into contact with a heated roller for a predetermined period of time.

Due to the relief-forming layer being crosslinked by heating, firstly, a relief formed after laser engraving becomes sharp and, secondly, tackiness of engraving residue formed when laser engraving is suppressed.

In addition, since by using a photopolymerization initiator or the like, the polymerizable compound is polymerized to form a crosslink, the crosslinking may be further carried out by means of light.

When the relief-forming layer comprises a photopolymerization initiator, the relief-forming layer may be crosslinked by irradiating the relief-forming layer with actinic radiation that triggers the photopolymerization initiator.

It is preferable to apply light to the entire surface of the relief-forming layer. Examples of the light (also called ‘actinic radiation’) include visible light, UV light, and an electron beam, but UV light is most preferably used. When the side where there is a substrate, such as a relief-forming layer support, for fixing the relief-forming layer, is defined as the reverse face, only the front face need be irradiated with light, but when the support is a transparent film through which actinic radiation passes, it is preferable to further irradiate the reverse face with light as well. When a protection film is present, irradiation from the front face may be carried out with the protection film as it is or after peeling off the protection film. Since there is a possibility of polymerization being inhibited in the presence of oxygen, irradiation with actinic radiation may be carried out after superimposing a polyvinyl chloride sheet on the relief-forming layer and evacuating.

### <Flexographic Printing Plate and Process for Making the Plate>

The process for making the flexographic printing plate of the present invention includes steps of preparing the flexographic printing plate precursor for laser engraving of the present invention, and laser-engraving the flexographic printing plate precursor for laser engraving to form a relief layer.

The flexographic printing plate of the present invention is obtained by the above process for making the flexographic printing plate.

The flexographic printing plate of the present invention can be suitably used for printing an aqueous ink.

### <Engraving Step>

The process for making a flexographic printing plate of the present invention preferably comprises an engraving step of laser-engraving the flexographic printing plate precursor having a (crosslinked) relief-forming layer.

The engraving step is a step of laser-engraving a (crosslinked) relief-forming layer that has been crosslinked in the crosslinking step to thus form a relief layer. Specifically, it is preferable to engrave a crosslinked relief-forming layer that has been crosslinked by irradiation with laser light according to a desired image, thus forming a relief layer. Furthermore, a step in which a (crosslinked) relief-forming layer is subjected to scanning irradiation by controlling a laser head using a computer in accordance with digital data of a desired image can preferably be cited.

This engraving step preferably employs an infrared laser. When irradiated with an infrared laser, molecules in the (crosslinked) relief-forming layer undergo molecular vibration, thus generating heat. When a high power laser such as a carbon dioxide laser or a YAG laser is used as the infrared laser, a large quantity of heat is generated in the laser-irradiated area, and molecules in the (crosslinked) relief-forming layer undergo molecular scission or ionization, thus being selectively removed, that is, engraved. The advantage of laser engraving is that, since the depth of engraving can be set freely, it is possible to control the structure three-dimensionally. For example, for an area where fine halftone dots are printed, carrying out engraving shallowly or with a shoulder prevents the relief from collapsing due to printing pressure, and for a groove area where a fine outline character is printed, carrying out engraving deeply makes it difficult for ink the groove to be blocked with ink, thus enabling breakup of an outline character to be suppressed.

In particular, when engraving is carried out using an infrared laser that corresponds to the absorption wavelength of the photothermal conversion agent, it becomes possible to selectively remove the (crosslinked) relief-forming layer at higher sensitivity, thus giving a relief layer having a sharp image.

As the infrared laser used in the engraving step, from the viewpoint of productivity, cost, etc., a carbon dioxide laser (a CO₂ laser) or a semiconductor laser is preferable. In particular, a fiber-coupled semiconductor infrared laser (FC-LD) is preferably used. In general, compared with a CO₂ laser, a semiconductor laser has higher efficiency laser oscillation, is less expensive, and can be made smaller. Furthermore, it is easy to form an array due to the small size. Moreover, the shape of the beam can be controlled by treatment of the fiber.

With regard to the semiconductor laser, one having a wavelength of 700 to 1,300 nm is preferable, one having a wavelength of 800 to 1,200 nm is more preferable, one having a wavelength of 860 to 1,200 nm is further preferable, and one having a wavelength of 900 to 1,100 nm is particularly preferable.

Furthermore, the fiber-coupled semiconductor laser can output laser light efficiently by being equipped with optical fiber, and this is effective in the engraving step in the present invention. Moreover, the shape of the beam can be controlled by treatment of the fiber. For example, the beam profile may be a top hat shape, and energy can be applied stably to the plate face. Details of semiconductor lasers are described in ‘Laser Handbook 2^{nd} Edition’ The Laser Society of Japan, and ‘Applied Laser Technology’ The Institute of Electronics and Communication Engineers, etc.

Moreover, as plate making equipment comprising a fiber-coupled semiconductor laser that can be used suitably in the process for making a flexographic printing plate employing the flexographic printing plate precursor of the present invention, those described in detail in JP-A-2009-172658 and JP-A-2009-214334 can be cited.

### <Other Steps>

The process for making a flexographic printing plate of the present invention may as necessary further comprise, subsequent to the engraving step, a rinsing step, a drying step, and/or a post-crosslinking step, which are shown below.

Rinsing step: a step of rinsing the engraved surface by rinsing the engraved relief layer surface with aqueous rinsing liquid (hereinafter, also simply referred to as “rinsing liquid”).

Drying step: a step of drying the relief layer after rinsing step.

Post-crosslinking step: a step of further crosslinking the relief layer by applying energy to the engraved relief layer.

After the above steps, a rinsing step of washing off engraving residue by rinsing the engraved surface with aqueous rinsing liquid may be added. The ‘aqueous rinsing liquid’ means water or a liquid containing water as the main component. The main component means the component comprised in the composition more than 50 mass % relative to the total weight of the composition. Examples of rinsing means include a method in which washing is carried out with tap water, a method in which high pressure water is spray-jetted, and a method in which the engraved surface is brushed in the presence of mainly water using a batch or conveyor brush type washout machine known as a photosensitive resin flexographic printing plate precursor, and when slime due to engraving residue cannot be eliminated, a rinsing liquid to which a soap or a surfactant is added may be used.

When the rinsing step of rinsing the engraved surface is carried out, it is preferable to add a drying step of drying an engraved relief-forming layer so as to evaporate rinsing liquid.

Furthermore, as necessary, a post-crosslinking step for further crosslinking the relief-forming layer may be added. By carrying out a post-crosslinking step, which is an additional crosslinking step, it is possible to further strengthen the relief formed by engraving.

The pH of the rinsing liquid that can be used in the present invention is preferably at least 9, more preferably at least 10, and yet more preferably at least 11. The pH of the rinsing liquid is preferably no greater than 14, more preferably no greater than 13.5, yet more preferably no greater than 13.2, particularly preferably no greater than 13, and most preferably no greater than 12.5. When in the above-mentioned range, handling is easy.

In order to set the pH of the rinsing liquid in the above-mentioned range, the pH may be adjusted using an acid and/or a base as appropriate, and the acid or base used is not particularly limited.

The rinsing liquid that can be used in the present invention preferably comprises water as a main component.

The rinsing liquid may contain as a solvent other than water a water-miscible solvent such as an alcohol, acetone, or tetrahydrofuran.

The rinsing liquid preferably comprises a surfactant.

From the viewpoint of removability of engraving residue and little influence on a flexographic printing plate, preferred examples of the surfactant that can be used in the present invention include ampholytic surfactants such as a carboxybetaine compound, a sulfobetaine compound, a phosphobetaine compound, an amine oxide compound, and a phosphine oxide compound.

Furthermore, examples of the surfactant also include known anionic surfactants, cationic surfactants, amphoteric surfactants, and nonionic surfactants. Moreover, a fluorine-based or silicone-based nonionic surfactant may also be used in the same manner.

With regard to the surfactant, one type may be used on its own or two or more types may be used in combination.

It is not necessary to particularly limit the amount of surfactant used, but it is preferably 0.01 to 20 mass % relative to the total weight of the rinsing liquid, and more preferably 0.05 to 10 mass %.

The flexographic printing plate of the present invention having a relief layer on the surface of any substrate such as a support etc. may be produced as described above.

From the viewpoint of satisfying suitability for various aspects of printing, such as abrasion resistance and ink transfer properties, the thickness of the relief layer of the flexographic printing plate is preferably at least 0.05 mm but no greater than 10 mm, more preferably at least 0.05 mm but no greater than 7 mm, and yet more preferably at least 0.05 mm but no greater than 3 mm.

Furthermore, the Shore A hardness of the relief layer of the flexographic printing plate is preferably at least 50° but no greater than 90°. When the Shore A hardness of the relief layer is at least 50°, even if fine halftone dots formed by engraving receive a strong printing pressure from a letterpress printer, they do not collapse and close up, and normal printing can be carried out. Furthermore, when the Shore A hardness of the relief layer is no greater than 90°, even for flexographic printing with kiss touch printing pressure it is possible to prevent patchy printing in a solid printed part.

The Shore A hardness in the present specification is a value measured at 25° C. by a durometer (a spring type rubber hardness meter) that presses an indenter (called a pressing needle or indenter) into the surface of a measurement target so as to deform it, measures the amount of deformation (indentation depth), and converts it into a numerical value.

The flexographic printing plate of the present invention is particularly suitable for printing by a flexographic printer using an aqueous ink, but printing is also possible when it is carried out by a relief printer using any of aqueous, oil-based, and UV inks, and printing is also possible when it is carried out by a flexographic printer using a UV ink.

The present inventors found that by using the resin composition containing Components A and B, a flexographic printing plate precursor for laser engraving that is excellent in rinsing properties for engraving residue and printing durability can be obtained.

Though the detailed mechanism thereof is unclear, it is assumed that since the difference of polarity between the resin composition and a general-purpose ink (aqueous ink) is increased by using (Component A) a hydrocarbon-based plastomer in the resin composition, resistance of the flexographic printing plate to the ink is increased, and as a result, the printing durability is improved.

However, on the other hand, in the resin composition using Component A, since the permeability of a rinsing liquid is deteriorated as well, rinsing properties after laser engraving tend to be deteriorated.

The inventors further added (Component B) a polyester resin to the above resin composition and found that by adding Component B, it is possible to impart excellent rinsing properties while maintaining the printing durability of a relief layer.

It is assumed that this is because the permeability of the rinsing liquid is increased by the high polarity of the polyester resin, or because due to depolymerization of the polyester, bonds of polyester skeleton are easily cut in laser-engraving step or rinsing step, and as a result, residues become finer.

In accordance with the present invention, there can be provided a resin composition for laser engraving which can give a flexographic printing plate that is excellent in rinsing properties for engraving residue generated at the time of laser engraving and printing durability, to provide a flexographic printing plate precursor for laser engraving that uses the above resin composition for laser engraving, and to provide a process for making a flexographic printing plate using the above flexographic printing plate precursor and the flexographic printing plate

### EXAMPLE

Hereinafter, the present invention will be described in more detail with reference to Examples, but the invention is not limited to the examples. Unless otherwise noted, “parts” and “%” respectively represent “parts by mass” and “mass %”. Moreover, unless otherwise noted, the number average molecular weight (Mn) and the weight average molecular weight (Mw) of the compounds in Examples represent values measured by gel permeation chromatography (GPC, elution: tetrahydrofuran).

The details of Components A to E used in respective Examples and Comparative Examples are as follows. Here, Mn represents the number average molecular weight.

### (Component A) Hydrocarbon-Based Plastomer

A-1: UBEPOL BR (registered trademark) 150L (manufactured by Ube Industries, Ltd.), polybutadiene, Mn=243,000, Tg=about −80° C., tensile permanent set=63%

A-2: UBEPOL BR (registered trademark) 130B (manufactured by Ube Industries, Ltd.), polybutadiene, Mn=175,000, Tg=about −80° C., tensile permanent set=65%

A-3: Nipol (registered trademark) BR1250H (manufactured by Nippon Zeon Corporation), polybutadiene, Mn=482,000, Tg=about −70° C., tensile permanent set=74%

A-4: Nipol (registered trademark) IR2200 (manufactured by Nippon Zeon Corporation), polyisoprene, Mn=472,000, Tg=about −60° C., tensile permanent set=53%

A-5: Epion 100A (manufactured by Kaneka Corporation), polyisobutylene, Mn=3,600, Tg=about −50° C.

A-6: TR2000 (manufactured by JSR Corporation), styrene-butadiene thermoplastic elastomer, Mn=94,000, Tg=about −80° C. and 100° C., tensile permanent set=3%

### (Component B) Polyester Resin

B-1: POLYESTER LP022 (manufactured by Nippon Synthetic Chemical Industry Co., Ltd.), Mn=10,000

B-2: Polylite OD-X-2376 (manufactured by DIC Corporation), Mn=1,000

B-3: Aronix (registered trademark) M-6250 (manufactured by Toagosei Co., Ltd.), Mn=94,000, Tg=about −80° C.

B-4: OLESTER (registered trademark) RA-2003 (manufactured by Mitsui Chemicals, Inc.), Mn=94,000, Tg=about −80° C.

B-5: Gohsenol (registered trademark) T-215 (manufactured by Nippon Synthetic Chemical Industry Co., Ltd.), polyvinyl alcohol

B-6: #3000-2 (manufactured by Denki Kagaku Kogyo Kabushiki Kaisha), polyvinyl butyral

B-7: Resamine ME8105LP (manufactured by Dainichiseika Color & Chemicals Mfg. Co., Ltd.), polyurethane

B-8: Amilan (registered trademark) CM4000 (manufactured by Toray Industries, Inc.), polyamide

### (Component C) Polymerization Initiator

Perbutyl (registered trademark) Z (manufactured by NOF Corporation, t-butylperoxybenzoate)

### (Component D) Polyfunctional Ethylenically Unsaturated Compound Having Two or More Radically Polymerizable Groups in a Molecule

D-1: 1,6-Hexanediol diacrylate (HDDA, manufactured by Dai-ichi Kogyo Seiyaku Co., Ltd.)

D-2: Trimethylolpropane triacrylate (NK Ester A-TMPT, manufactured by Shin-Nakamura Chemical Co., Ltd.)

### (Component E) Photothermal Conversion Agent

Carbon black #45L (manufactured by Mitsubishi Chemical Corporation, particle diameter: 24 nm, specific surface area: 125 m²/g, DBP oil absorption amount: 45 cm³/100 g)

### Examples 1 to 16 and Comparative Examples 1 to 7

### 1. Preparation of Resin Composition for Laser Engraving

Component B described in Table 1 was put into a three-neck flask equipped with a stirring blade and a cooling tube in the amount described in Table 1. Further, propylene glycol monomethyl ether acetate of the same parts by weight as that of Component B was added thereto as a solvent, and the mixture was heated at 70° C. for 180 hours while stirring to dissolve Component B.

Then, the solution was cooled to 40° C., and Components A, C, D, and E described in Table 1 were added thereto, followed by stirring for 30 minutes. The amount of the respective components used (parts by mass) were the same as those described in Table 1, and the components described as “-” in Table 1 were not added.

By the above operation, coating solutions for a relief-forming layer having fluidity (resin compositions for laser engraving) were obtained respectively.

### 2. Preparation of Flexographic Printing Plate Precursor for Laser Engraving

A spacer (frame) having a predetermined thickness was placed on a polyethylene terephthalate (PET) substrate. Thereafter, each of the resin compositions obtained as above was gently cast such that it did not overflow from the spacer, and dried in an oven at 70° C. for 3 hours. Then, the resin composition was heated at 80° C. for 3 hours and further heated at 100° C. for 3 hours so as to provide a (crosslinked) relief-forming layer having a thickness of about 1 mm. In this manner, flexographic printing plate precursors for laser engraving were prepared.

### 3. Preparation of Flexographic Printing Plate by Laser Engraving

From the flexographic printing plate precursor for laser engraving, the spacer was removed and the PET was peeled off. Thereafter, in an area of 1 cm² of the (crosslinked) relief-forming layer, a thalweg and a ridge line with a width of 100 μm were alternately engraved at an interval of 100 by using two types of lasers described below, and additionally, a solid area of 1 cm² of the (crosslinked) relief-forming layer was raster-engraved, whereby a flexographic printing plate was obtained.

With respect to Examples 1 to 3 and Comparative Example 1 in which the resin composition does not include a photothermal conversion agent, laser engraving was performed using a carbon dioxide laser engraving machine. Specifically, as the carbon dioxide laser engraving machine, a high-quality CO₂ laser marker ML-9100 series (manufactured by Keyence Corporation) was used under engraving conditions of an output of 12 W, a head speed of 200 mm/sec, and a pitch setting of 2,400 DPI.

With respect to Examples 4 to 16 and Comparative Examples 2 to 7 in which the resin compositions include photothermal conversion agents, as a semiconductor laser engraving machine, a laser recording device equipped with a fiber-coupled semiconductor laser (FC-LD) SDL-6390 (manufactured by JDS Uniphase Corporation, wavelength: 915 nm) with a maximum output of 8.0 W was used. Using the semiconductor laser engraving machine, laser engraving was performed under conditions of a laser output of 7.5 W, a head speed of 409 mm/sec, and a pitch setting of 2,400 DPI.

All of the thicknesses of the relief layers of respective flexographic printing plates obtained in Examples 1 to 16 and Comparative Examples 1 to 7 were about 1 mm

### Evaluation of Flexographic Printing Plate

The performance of the flexographic printing plate was evaluated in terms of the following items. The results are shown in Table 1.

### (4-1) Rinsing Properties

The laser-engraved plate was immersed in water, and the engraved portion was rubbed 10 times against a toothbrush (manufactured by Lion Corporation, Clinica toothbrush flat). Thereafter, the surface of the relief layer was observed with an optical microscope so as to check for the presence of residue. A plate having no residue was given a 1, a plate having practically no residue was given a 2, a plate having a small amount of residue was given a 3, and a plate from which residue could not be removed was given a 4.

### (4-2) Printing Durability

The obtained relief printing plate was set in a printer (ITM-4 model, manufactured by Iyo Kikai Seisakusho Co., Ltd.). As an ink, an aqueous ink Aqua SPZ16 Crimson (manufactured by Toyo Ink Co., Ltd.) was used without dilution to continuously perform printing on Full Color Form M70 printing paper (manufactured by Nippon Paper Industries Co., Ltd., thickness of 100 μm), and a highlight of 1% to 10% was checked in the printed matter. A point in time when a halftone dot was not printed was taken as a printing end-point, and the length (meter) of the paper used for printing the end-point was taken as an index. As the length of the paper increased, the printing plate was evaluated to be excellent in printing durability.

TABLE 1

| | | Component A | | Component B | Component C |
|---|---|---|---|---|---|
| | | Content | | Content | Content |
| | Component A | (parts by mass) | Component B | (parts by mass) | (parts by mass) |
| Ex. 1 | A-1 | 60 | B-1 | 40 | — |
| Ex. 2 | A-1 | 50 | B-1 | 45 | 5 |
| Ex. 3 | A-1 | 40 | B-1 | 40 | 5 |
| Ex. 4 | A-1 | 37 | B-1 | 37 | 5 |
| Ex. 5 | A-1 | 21 | B-1 | 53 | 5 |
| Ex. 6 | A-1 | 53 | B-1 | 21 | 5 |
| Ex. 7 | A-2 | 37 | B-1 | 37 | 5 |
| Ex. 8 | A-3 | 37 | B-1 | 37 | 5 |
| Ex. 9 | A-4 | 37 | B-1 | 37 | 5 |
| Ex. 10 | A-5 | 37 | B-1 | 37 | 5 |
| Ex. 11 | A-1 | 37 | B-2 | 37 | 5 |
| Ex. 12 | A-1 | 37 | B-3 | 37 | 5 |
| Ex. 13 | A-1 | 37 | B-4 | 37 | 5 |
| Ex. 14 | A-1 | 21 | B-3 | 53 | 5 |
| Ex. 15 | A-1 | 53 | B-3 | 21 | 5 |
| Ex. 16 | A-1 | 37 | B-1 | 37 | 5 |
| Comp. Ex. 1 | A-1 | 100 | — | — | — |
| Comp. Ex. 2 | A-1 | 74 | — | — | 5 |
| Comp. Ex. 3 | A-1 | 37 | B-6 | 37 | 5 |
| Comp. Ex. 4 | A-1 | 71 | B-7 | 3 | 5 |
| Comp. Ex. 5 | A-1 | 37 | B-8 | 37 | 5 |
| Comp. Ex. 6 | A-1 | 37 | B-9 | 37 | 5 |
| Comp. Ex. 7 | A-6 | 37 | B-3 | 37 | 5 |

| | | Component D | Component E | | |
|---|---|---|---|---|---|
| | | Content | Content | Rinsing | Printing durability |
| | Component D | (parts by mass) | (parts by mass) | properties | (m) |
| Ex. 1 | — | — | — | 1 | 85,000 |
| Ex. 2 | — | — | — | 2 | 90,000 |
| Ex. 3 | D-1 | 15 | — | 2 | 100,000 |
| Ex. 4 | D-1 | 16 | 5 | 1 | 110,000 |
| Ex. 5 | D-1 | 16 | 5 | 1 | 100,000 |
| Ex. 6 | D-1 | 16 | 5 | 2 | 125,000 |
| Ex. 7 | D-1 | 16 | 5 | 1 | 110,000 |
| Ex. 8 | D-1 | 16 | 5 | 2 | 105,000 |
| Ex. 9 | D-1 | 16 | 5 | 2 | 115,000 |
| Ex. 10 | D-1 | 16 | 5 | 1 | 100,000 |
| Ex. 11 | D-1 | 16 | 5 | 1 | 110,000 |
| Ex. 12 | D-1 | 16 | 5 | 1 | 130,000 |
| Ex. 13 | D-1 | 16 | 5 | 2 | 130,000 |
| Ex. 14 | D-1 | 16 | 5 | 1 | 135,000 |
| Ex. 15 | D-1 | 16 | 5 | 1 | 145,000 |
| Ex. 16 | D-2 | 16 | 5 | 1 | 120,000 |
| Comp. Ex. 1 | — | — | — | 4 | 50,000 |
| Comp. Ex. 2 | D-1 | 16 | 5 | 4 | 110,000 |
| Comp. Ex. 3 | D-1 | 16 | 5 | 4 | 100,000 |
| Comp. Ex. 4 | D-1 | 16 | 5 | 4 | 71,000 |
| Comp. Ex. 5 | D-1 | 16 | 5 | 3 | 70,000 |
| Comp. Ex. 6 | D-1 | 16 | 5 | 3 | 70,000 |
| Comp. Ex. 7 | D-1 | 16 | 5 | 3 | 100,000 |

What is claimed is:

1. A resin composition for laser engraving, comprising:
(Component A) a hydrocarbon-based plastomer; and
(Component B) a polyester resin.

2. The resin composition for laser engraving according to claim 1,
wherein Component A contains at least one resin selected from a group consisting of a polyolefin resin and a poly-conjugated diene-based resin.

3. The resin composition for laser engraving according to claim 1,
wherein Component A is polybutadiene or polyisoprene.

4. The resin composition for laser engraving according to claim 1,
wherein the content of Component A is 15 mass % to 70 mass % relative to the amount of the solid content of the resin composition.

5. The resin composition for laser engraving according to claim 1,
wherein the content of Component B is 15 mass % to 70 mass % relative to the amount of the solid content of the resin composition.

6. The resin composition for laser engraving according to claim 1, further comprising (Component C) a polymerization initiator,
wherein Component B is a polyester resin having a radically polymerizable group in a molecule.

7. The resin composition for laser engraving according to claim 6,
wherein the content of Component C is 5 mass % to 15 mass % relative to the amount of the solid content of the resin composition.

8. The resin composition for laser engraving according to claim 1, further comprising (Component D) a polyfunctional ethylenically unsaturated compound having two or more radically polymerizable groups in a molecule.

9. The resin composition for laser engraving according to claim 8,
wherein the content of Component D is 3 mass % to 20 mass % relative to the amount of the solid content of the resin composition.

10. The resin composition for laser engraving according to claim 1, further comprising (Component E) a photothermal conversion agent.

11. The resin composition for laser engraving according to claim 10,
wherein the content of Component E is 2 mass % to 60 mass % relative to the amount of the solid content of the resin composition.

12. The resin composition for laser engraving according to claim 10,
wherein Component C is an organic peroxide, and Component E is carbon black.

13. A flexographic printing plate precursor for laser engraving, comprising:
a relief-forming layer which is formed of the resin composition for laser engraving according to claim 1 and is provided on a support.

14. A flexographic printing plate precursor for laser engraving, comprising:
a crosslinked relief-forming layer which is obtained by crosslinking the relief-forming layer formed of the resin composition for laser engraving according to claim 6 by heat and/or light, and which is provided on a support.

15. The flexographic printing plate precursor for laser engraving according to claim 14,
wherein the crosslinked relief-forming layer is obtained by crosslinking by heat.

16. A process for producing a flexographic printing plate precursor for laser engraving, comprising steps of:
forming a relief-forming layer formed of the resin composition for laser engraving according to claim 6; and
crosslinking the relief-forming layer by heat and/or light so as to obtain a flexographic printing plate precursor having a crosslinked relief-forming layer.

17. The process for producing a flexographic printing plate precursor for laser engraving according to claim 16,
wherein in the step of crosslinking, the relief-forming layer is crosslinked by heat.

18. A process for making a flexographic printing plate, comprising steps of:
preparing the flexographic printing plate precursor for laser engraving according to claim 13; and
engraving the flexographic printing plate precursor for laser engraving with laser so as to form a relief layer.

19. The process for making a flexographic printing plate according to claim 18, further comprising, after the step of engraving, a step of rinsing the surface of the relief layer with an aqueous rinsing liquid.

20. A flexographic printing plate made by the process for making a flexographic printing plate according to claim 18.
